(19) United States
(12) Patent Application Publication
(10) Pub. No.: US 2026/0245978 A1
(43) Pub. Date: Aug. 20, 2026

(54) PYRROLIDINIUM CATION HAVING AT LEAST ONE FUNCTIONAL GROUP FOR ZINC BATTERIES

(71) Applicant: U.S. Army DEVCOM, Army Research Laboratory, Adelphi, MD (US)

(72) Inventors: Glenn R. Pastel, Silver Spring, MD (US); Kang Xu, Potomac, MD (US); Marshall A. Schroeder, Pasadena, MD (US); Travis P. Pollard, Rockville, MD (US); Oleg A. Borodin, Laurel, MD (US); Zhengcheng Zhang, Napersville, OH (US); Qian Liu, Bolingbrook, IL (US)

(73) Assignee: U.S. Government, as Represented by the Secretary of the Army, Adelphi, MD (US)

(21) Appl. No.: 19/542,252

(22) Filed: Feb. 17, 2026

Related U.S. Application Data
(60) Provisional application No. 63/760,934, filed on Feb. 20, 2025.

(51) Int. Cl. H01M 10/26; H01M 4/42; H01M 4/48; H01M 4/60; H01M 6/04

(52) U.S. Cl. CPC H01M 10/26; H01M 4/42; H01M 4/48; H01M 4/606; H01M 6/045; H01M 2300/0014

(57) ABSTRACT

We disclose the application and use of a class of electrolyte additives formed of a pyrrolidinium cation with at least one functional group, and an anion for zinc-batteries. For instance, the additive molecule may be 1-methyl-1-(2,2,3,3,3-pentafluoropropyl)pyrrolidinium bis(trifluoromethylsulfonyl)imide, as one non-limiting example. As a minority component (e.g., ≤5% by mass), the additive produces significant improvements in the performance of zinc batteries with aqueous and non-aqueous electrolytes, across multiple metrics. These results are attributed to favorable reactions involving the functional groups of the pyrrolidinium cation that impact the interphase chemistry and result in suppression of parasitic reactions including the hydrogen evolution reaction.

### RELATED APPLICATION

This application claims benefit to U.S. Provisional Patent Application No. 63/760,934 titled “Pyrrolidinium Cation Having at least one Functional Group for Zinc Batteries” that was filed on Feb. 20, 2025 (ARL Ref: ARL 23-19P), herein incorporated by reference in its entirety.

### GOVERNMENT INTEREST

The invention described herein may be manufactured, used and licensed by or for the U.S. Government without the payment of royalties thereon.

### RESEARCH AND RELATED DISCLOSURES

Research underlying the invention was funded the Joint Center for Energy Storage Research (JCESR), an Energy Innovation Hub funded by the U.S. Department of Energy (DOE), Office of Science, Basic Energy Sciences (BES), and U.S. Army DEVCOM Army Research Laboratory (DEVCOM ARL). The DOE and ARL were working together under Inter-Agency Agreement No. 89243019SSC000028.

Some aspects of this invention have been previously disclosed by the inventors in the following paper: Glenn R. Pastel et al., “Designing interphases for highly reversible aqueous zinc batteries,” Joule, Vol. 8, 17 Apr. 2024, pp. 1050-1062 (first published Feb. 23, 2024), which was incorporated in and formed a basis of the '934 prov. patent application, and herein incorporated by reference in its entirety for all purposes.

This application is related to U.S. patent application Ser. No. 19/542,303 titled “Onium Cation with Ether Linkages for Zinc Batteries” which was filed on Feb. 17, 2026 (ARL Ref: ARL 23-22), herein incorporated by reference in its entirety for all purposes.

### BACKGROUND OF THE INVENTION

### Field

Embodiments of the present invention are directed to battery chemistry and, more particularly, to electrolyte additives for zinc batteries.

### Description of Related Art

Batteries are ubiquitous on the battlefield in the form of wearables, manned and unmanned vehicles, stationary storage, and many other applications. Zinc batteries provide a safer and more sustainable alternative to conventional lithium-ion batteries. Zinc metal batteries can also achieve high volumetric energy densities which are well suited to military applications with challenging size constraints. Efforts to improve zinc metal anode reversibility in aqueous electrolytes have primarily focused on tailoring Zn²⁺ solvation.

Currently, zinc batteries use a corrosive KOH-based electrolyte. These suffer parasitic reactions including hydrogen evolution, corrosion, and other reactions, they have limited reversibility and cycle life. As a result, state-of-the-art aqueous zinc electrolytes are not capable of high areal capacities and current densities with reasonable efficiency (1 mAh cm⁻², 1 mA cm⁻², and >90%, respectively). For rechargeable zinc batteries to achieve greater market penetration, electrolytes with significantly better performance must be developed.

In light of the foregoing, improvements for zinc metal battery electrolytes are desired.

### BRIEF SUMMARY OF THE INVENTION

The present invention relates to the application and use of a class of electrolyte additives formed of a pyrrolidinium cation with at least one functional group, and an anion for zinc-batteries.

For instance, the pyrrolidinium cation may be 1-methyl-1-(2,2,3,3,3-pentafluoropropyl)pyrrolidinium, 1-methyl-1-(2,2,2-trifluoroethyl)pyrrolidinium, or 1-methyl-1-(2,2,3,3,4,4,4-heptafluorobutyl)pyrrolidinium, as non-limiting examples. The at least one functional group may be selected from the group consisting of alkyl, alkene, alkenyl, alkynyl, F, CN, carbonate, ester, cyano-substituted alkyl groups, perfluoro, partially-fluorinated groups, ether(s), alcohol, SOₓ, O₂SOR (where R is a Si containing species), O₂SR (where R is fluorine, perfluoro, or other partially fluorinated species bonded to the sulfur atom) and combinations thereof, as non-limiting examples. In one particular embodiment, the at least one functional group is —CH₂—CF₂—CF₃.

The anion may be selected from the group consisting of: bis(trifluoromethane sulfonyl)imide (TFSI), bis(fluorosulfonyl)imide (FSI), trifluoromethanesulfonate (OTf), hexafluorophosphate (PF₆), perchlorate (ClO₄), tetrafluoroborate (BF₄), bis(oxalato)borate (BOB), difluoro(oxalate)borate (DFOB), sulfate (SO₄), nitrate (NO₃), chloride, bromide, fluoride, iodide, acetate, and combinations thereof, as non-limiting examples.

The additive molecule may be 1-methyl-1-(2,2,3,3,3-pentafluoropropyl)pyrrolidinium bis(trifluoromethylsulfonyl)imide, as one non-limiting example.

As a minority component (e.g., ≤5% by mass/weight), the additive produces significant improvements in the performance of zinc batteries, across multiple metrics. These results are attributed to favorable reactions impacting the interphase chemistry involving the functional groups of the pyrrolidinium cation, resulting in suppression of parasitic reactions, including the hydrogen evolution reaction, and less corrosion.

These and other embodiments of the invention are described in more detail, below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments, including less effective but also less expensive embodiments which for some applications may be preferred when funds are limited. These embodiments are intended to be included within the following description and protected by the accompanying claims.

FIG. 1 shows a schematic illustration of a zinc battery according to embodiments.

FIG. 2A depicts the molecular formula of the 1-methyl-1-(2,2,3,3,3-pentafluoropropyl)pyrrolidinium bis(trifluoromethylsulfonyl)imide (PfmPyr(TFSI)) compound, and FIGS. 2B and 2C depict the 3D molecular renderings of the chemical structures of the 1-methyl-1-(2,2,3,3,3-pentafluoropropyl)pyrrolidinium cation and the bis(trifluoromethylsulfonyl)imide anion, respectively.

FIGS. 3A and 3B show reductive and oxidative linear sweep voltammograms of the electrolyte 3.8 molal (m) of zinc bis(trifluoromethane) sulfonyl imide Zn(TFSI)₂ dissolved in water, with and without the 1-methyl-1-(2,2,3,3,3-pentafluoropropyl)pyrrolidinium bis(trifluoromethylsulfonyl)imide (PfmPyr) additive molecule, resulting in substantially lower background corrosion currents for the former.

FIG. 4 shows extended galvanostatic cycling tests of Zn∥Zn symmetric cells with the PfmPyr(TFSI) additive at 1 mA cm⁻² current density and 1 mAh cm⁻² capacity per step.

FIG. 5A shows the voltage profile for the galvanostatic cycling tests of Cu∥Zn cells using the Aurbach protocol which correspond to the larger dataset of compositions in FIG. 5B.

FIGS. 6A and 6B are photographs from focused-ion beam cross sections viewed by scanning electron microscopy depicting the morphological changes to the zinc deposits due to the additive.

FIG. 7 shows the X-ray photoelectron spectra (XPS) of the surface of the zinc deposited with and without the PfmPyr(TFSI) additive.

### DETAILED DESCRIPTION

We describe the application of a relatively new class of electrolyte additives for use in zinc batteries. Zinc batteries are an alternative to lithium-based batteries which use more abundant materials and leverage the high volumetric capacity of zinc metal. General parameters of zinc batteries are disclosed in Lin Ma et al., “Critical Factors Dictating Reversibility of the Zinc Metal Anode,” Energy Environ. Mater. 2020, 3, 516-521, and corresponding U.S. Patent Application Publication No. 2023/0223595 titled “Heterocyclic Electrolyte Additives for Rechargeable Metal Batteries,” which published Jul. 13, 2023, both of which are herein incorporated by reference in their entireties.

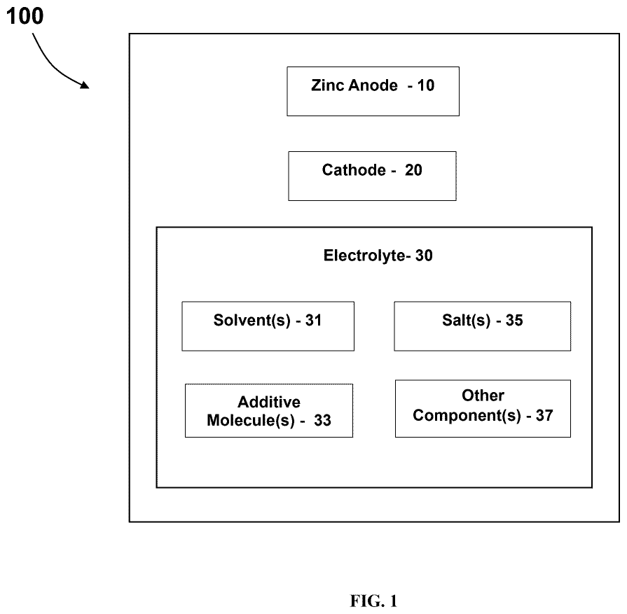

FIG. 1 shows a schematic illustration of a zinc battery 100 according to embodiments. The zinc batteries utilize a zinc metal/alloys anode 10 which offers high theoretical volumetric capacity (5884 mAh cm⁻³). The cathode 20 may be formed of a vanadium oxide inorganic compound (HNaV₆O₁₆), a gaseous mixture with oxygen, or an electrochemically-active organic compound such as polyaniline, as non-limiting examples. An electrolyte composition 30 is provided.

The composition 30 includes base electrolyte solvent(s) 31, additive molecule(s) 33, salt(s) 35, and other component(s) 37. The base electrolyte solvent(s) 31 may include one or more liquids commonly used as solvents for electrolytic solutions comprising upwards to nearly 100 weight % ratio. For aqueous solutions, water is used as the sole or primary liquid. Non-aqueous solutions can include alcohols, acids, ethers, carbonates (linear and cyclic), sulfonates, ketones, or hydrocarbons, as non-limiting examples, and can comprise upwards to 100 weight % ratio.

The additive molecule(s) 33 includes at least one molecule formed of a pyrrolidinium cation, with at least one functional (i.e., reactive) group, and an anion. The pyrrolidinium cation is a heterocyclic compound with five members including a protonated nitrogen, and two functional groups with some degree of fluorination.

The functional group may be selected from the group consisting of alkyl, alkene, alkenyl, alkynyl, F, CN, carbonate, ester, cyano-substituted alkyl groups, perfluoro, partially-fluorinated groups, ether(s), alcohol, SOₓ, O₂SOR (where R is a Si containing species), O₂SR (where R is fluorine, perfluoro, or other partially fluorinated species bonded to the sulfur atom), for example. More particularly, the functional group may be —CH₂—CF₂—CF₃; this functional group is hydrophobic and contains fluorine which can form stable solid electrolyte interphase (SEI) species. The hydrophobicity of the group is important for pushing water away from the interphase during reduction and thereby obstructing parasitic hydrogen evolution due to water reduction. The hydrophobicity of the group also explains the poor solubility of the cation in aqueous solutions with low concentration(s) of solute.

The anion may be selected from the group consisting of: bis(trifluoromethane sulfonyl)imide (TFSI), bis(fluorosulfonyl)imide (FSI), trifluoromethanesulfonate (OTf), hexafluorophosphate (PF₆), perchlorate (ClO₄), tetrafluoroborate (BF₄), bis(oxalato)borate (BOB), difluoro(oxalato)borate (DFOB), sulfate (SO₄), nitrate (NO₃), chloride, bromide, fluoride, iodide, acetate, or any combination thereof, for example.

In some embodiments, the additive includes a longer or short cyclic functional group with more or less fluorine species. In some embodiments, the other functional group is similarly varied. In some embodiments, the five-membered ring is partially or fully fluorinated, although, with fluorination, the molecule may be less soluble; and/or require different loadings. The additive molecule(s) 33 is a minority component in the solution (e.g., ≤5% by weight). Our results suggest that reactions involving certain functional groups stabilize the zinc metal anode by changing the interphase chemistry and reducing anion decomposition, resulting in suppression of parasitic reactions including the hydrogen evolution reaction, improved interphases, and less corrosion. The same effects are not seen in lithium-ion batteries. This is due to the nature of the redox reactions involved, the electrochemical window and the anode SEI. The zinc stripping and plating redox reaction occurs at a much higher potential than conventional lithium-ion negative electrode redox reactions (−0.76 V vs. ~−2.9V relative to SHE, respectively). The stripping and plating reaction also occurs without a host or intercalating structure, thereby imposing high stresses on the anode SEI. Electrolytes must be specifically designed to accommodate these differences. Therefore, zinc is a unique application in this regard and the use of water as the primary solvent also contributes to improved safety and unparalleled electrolyte design considerations relative to other non-aqueous lithium-ion and sodium-ion electrolytes.

In some embodiments, the additive molecule(s) 33, include at least one molecule formed of a pyrrolidinium cation, with at least one functional (i.e., reactive) group, and an anion, along with an additional additive molecule include at least an onium cation having at least one ether linkage and an imide anion, as disclosed in the related '303 patent application (ARL Ref: ARL 23-22). There may be tradeoffs in terms of performance and optimization may be further required. For instance, adding TDMA(TFSI) to PfmPyr(TFSI) resulted in longer Zn∥Zn cycle life (less dendrite growth), but PfmPyr(TFSI) contributes a lower overpotential. Other potential combinations of the additive molecule classes may indeed be advantageous and/or synergistic for zinc batteries. The concentrations thereof when combined may need to be varied compared their use individually.

Salt(s) 35 may include various dissociated salts, such as imides, sulfates, and hydroxides, as non-limiting examples. The salt(s) may also include at least one metal salt. The metal salt may have a cation selected from the group consisting of: zinc (Zn), lithium (Li), sodium (Na), potassium (K), iron (Fe), magnesium (Mg), calcium (Ca), vanadium (V), aluminum (Al), and any combination thereof. And the metal salt may have an anion selected from the group consisting of: bis(trifluoromethane sulfonyl)imide (TFSI), bis(fluorosulfonyl)imide (FSI), trifluoromethanesulfonate (OTf), hexafluorophosphate (PF₆), perchlorate (ClO₄), tetrafluoroborate (BF₄), bis(oxalato)borate (BOB), difluoro(oxalato)borate (DFOB), sulfate (SO₄), nitrate (NO₃), chloride, bromide, fluoride, iodide, acetate, or a combination thereof. The concentration of the metal salts may be between 0.1 molal and 30 molal in the electrolyte composition.

Other component(s) 37 may optionally be included in the electrolyte solution at low concentrations. (e.g., ≤5% by weight). These can assist with solubility since the cation is hydrophobic and does not dissociate without a high concentration of solute or nonaqueous solvents. The pyrrolidinium cation is highly hydrophobic and therefore does not dissociate in aqueous media without high concentrations of solute or additional nonaqueous solvents. Polymer(s), such as polyethylene glycol, polyethylene oxide, poly(vinylidene fluoride-co-hexafluoropropylene), may be incorporated into the electrolyte to provide additional benefits related to performance and structural integrity. One or more of hydroxides, chlorides, sulfates, zinc acetate, zinc nitrate, zinc trifluoromethanesulfonate, and zinc bis(trifluoromethylsulfonyl)imide may be further added to the baseline electrolyte to further provide conductivity, SEI reagents, and a zinc source. The anion chemistry impacts many properties including conductivity, interphase chemistry, corrosion resistance, toxicity, and reversibility.

Moreover, the electrolyte may include a catholyte and/or anolyte or can be used in a flow battery configuration. In some embodiments, the additive is used for a zinc-air battery, zinc-ion battery, zinc hybrid supercapacitor, zinc-halide battery, zinc-iron redox flow battery, zinc-cerium redox flow battery, zinc-silver battery, zinc-organic cathode battery, zinc-MnO₂, or a zinc hybrid battery with two active cations.

The exact composition of the additive, synthesis process, baseline electrolyte, and/or electrodes in the zinc battery 10 can be varied within the bounds of this invention.

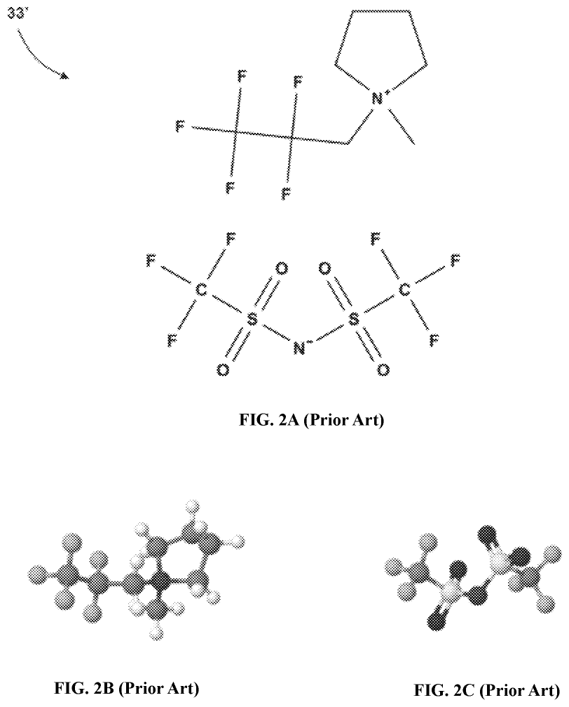

FIG. 2A depicts the molecular structure of the 1-methyl-1-(2,2,3,3,3-pentafluoropropyl)pyrrolidinium bis(trifluoromethylsulfonyl)imide (PfPyr) molecule, 33′ and FIGS. 2B and 2C depict 3D molecular renderings of the chemical structures of the 1-methyl-1-(2,2,3,3,3-pentafluoropropyl)pyrrolidinium cation and the bis(trifluoromethylsulfonyl)imide anion, respectively. The chemical formula is (C₈F₅H₁₃N)⁺(C₂F₆NO₄S₂)—. The Simplified Molecular Input Line Entry System (SMILES) string for this molecule is as follows: cation=C[N+]1(CC(F)(F)C(F)(F)F)CCCC1 anion=C(F)(F)(F)S(═O) (═O)[N—]S(═O)(═O)C(F)(F)F}. The molar mass of the molecule is 498.33 amu=cation 218.19 amu+TFSI anion 280.14 amu.

This molecule was developed for lithium-based batteries by researchers at the Argonne National Laboratory, two of which are co-inventors of the present invention: Qian Liu and Zhengcheng Zhang. See Qian Liu et al., “A fluorine-substituted pyrrolidinium-based ionic liquid for high-voltage Li-ion battery,” Chem. Commun., 2020, 56, 7317-7320, herein incorporated by reference in its entirety. This compound was designed to include a reactive cation with a five-membered ring with protonated nitrogen and partially fluorinated alkyl group and an imide anion for oxidative reactions on the cathode in lithium battery applications. The same reactions are not pertinent to this invention.

It is not easy to use lithium-ion electrolyte components for zinc batteries due to a couple of factors: (1) zinc has a very different potential (−0.76 V vs SHE) which requires completely different SEI formers than lithium-ion batteries (Li⁺/Li is −3.04 V vs SHE), (2) The stripping and plating reaction in zinc batteries imposes high stresses on the anode SEI relative to Li-ion intercalation materials, (3) aqueous solvents require a completely different interphase chemistry to avoid HER/OER, (4) the solubility of the additive is very poor in water, therefore a unique concentrated electrolyte or co-solvent mixture is required that was non-trivial to optimize, (5) the effect on the interphase for lithium and zinc batteries is completely different (impacting the cathode versus anode interphase chemistry, respectively) and the impacted materials are not interchangeable between the two applications (4.2 V layered oxide in LIB and zinc anode in the zinc battery).

We synthesized 1-methyl-1-(2,2,3,3,3-pentafluoropropyl)pyrrolidinium bis(trifluoromethylsulfonyl)imide (PfmPyr) using a three-step technique as reported in the 2020 Qian Liu et al., Chem. Commun. paper. In brief, we prepared and reacted 1-(2,2,3,3,3-pentafluoropropyl)pyrrolidine with CH₃TFSI.

This molecule may be used in zinc batteries according to embodiments of the present invention. But other variations of the additive class may also be used. Besides the 1-methyl-1-(2,2,3,3,3-pentafluoropropyl)pyrrolidinium cation, 1-methyl-1-(2,2,2-trifluoroethyl)pyrrolidinium cation, or 1-methyl-1-(2,2,3,3,4,4,4-heptafluorobutyl)pyrrolidinium cation may also be used. Likewise, other anions could be used for the additive molecule. TFSI was selected as the anion because it aligned with previous efforts and is soluble up to high concentrations. However, imide ions (TFSI specifically) could be phased out in the future due to their cost and classification as PFAS chemicals.

This compound additive class reduces parasitic side reactions in zinc metal batteries including interphase instability, dendrite growth, zinc corrosion, self-discharge, hydrogen evolution, and anion/salt decomposition in zinc batteries. For instance, this can include (1) rechargeable zinc metal batteries including: zinc-air, zinc-ion, zinc hybrid supercapacitor, zinc-bromide, zinc-iodide, zinc-iron redox flow, zinc-cerium redox flow, zinc-silver, zinc-organic cathode battery, zinc-MnO₂, or a zinc hybrid battery with two active cations; (2) primary zinc batteries. The latter can include primary (non-rechargeable) zinc batteries with Zn-air and Zn—Ag chemistries are currently used in hearing aids and other medical devices, respectively.

The technology will enable better rechargeable zinc metal batteries for applications including grid energy storage, portable electronic devices, and electric vehicles. Moreover, it does not require modifications to the manufacturing process and only a small amount (e.g., ≤5%) of the material can drastically improve performance. Additionally, applications might extend to other battery technologies with metal or anodes, such as iron and lead.

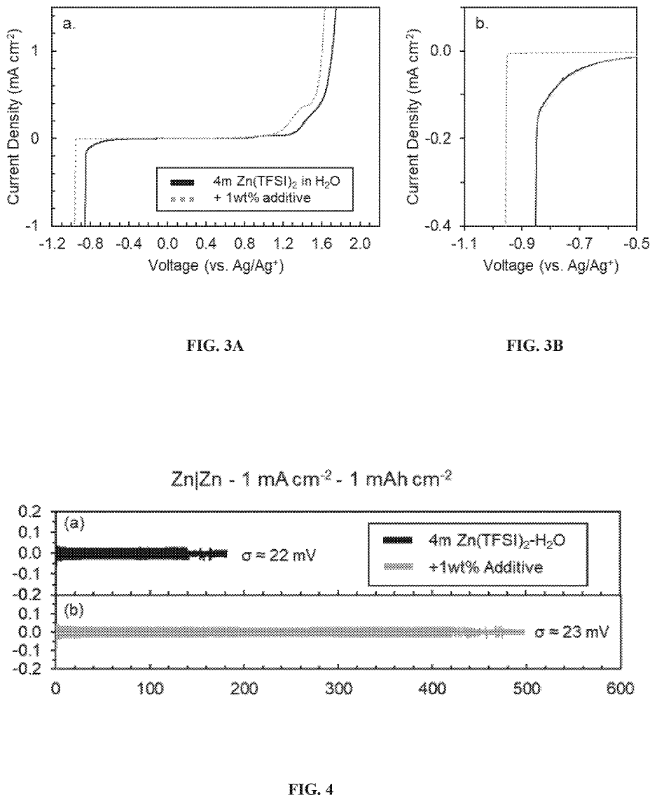

FIGS. 3A and 3B show reductive and oxidative linear sweep voltammograms of the electrolyte 3.8 molal (m) of zinc bis(trifluoromethane) sulfonyl imide Zn(TFSI)₂ dissolved in water, with and without the 1-methyl-1-(2,2,3,3,3-pentafluoropropyl)pyrrolidinium bis(trifluoromethylsulfonyl)imide (PfmPyr(TFSI)) additive molecule, resulting in greatly different reductive stability and background corrosion currents. The linear sweep voltammetry experiments were conducted using with a stainless-steel working electrode, carbon counter electrode, and silver/silver chloride reference electrode at 1 mV sec⁻¹. This is a corrosion experiment that tests for HER without conflicting effects due to the zinc anode. Notably, the pyrrolidinium additive shows the best performance as a low weight-percent additive with the particular imide anion.

FIG. 4 shows extended galvanostatic cycling tests of Zn∥Zn symmetric cells with the additive at 1 mA cm⁻² current density and 1 mAh cm⁻² capacity per step. The change in interphase chemistry and morphology improves the reversibility of the zinc anode. This is important to test without bias from the cathode. Notably, the PfmPyr additive only slightly increases the overpotential, but results in an over 3× improvement in cycle lifetime. This also indicates a substantial improvement over the standard KOH based electrolyte control, which is unstable within 50 hours of cycling under the same conditions. These represent a huge step toward commercially viable zinc metal batteries. Coulombic efficiencies above 99% are feasible under high areal capacities up to at least 5 mAh cm⁻² and 5 mA cm⁻² current density.

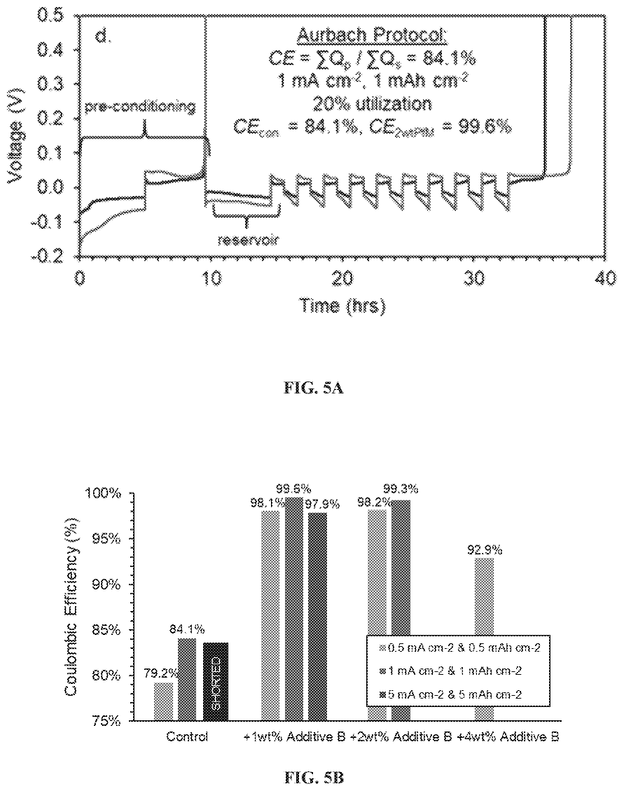

FIG. 5A shows the voltage profile for the galvanostatic cycling tests of Cu∥Zn cells using an Aurbach cycling protocol with a larger dataset of various compositions and current densities given in FIG. 5B. More specifically, FIG. 5A shows galvanostatic cycling tests of Cu∥Zn cells with the PfmPyr(TFSI) additive at 1, 2, and 4 wt %, using test conditions derived from the Aurbach Coulombic efficiency protocol (doi: 10.1149/1.2096425). The Aurbach protocol uses a 5 mAh cm⁻² reservoir and 20% utilization for 10 cycles before stripping away as much of the remaining reservoir as possible. The results indicate an increase in Coulombic efficiency from 84.1% to 99.6% relative to a baseline electrolyte without the pyrrolidinium additive. FIG. 5B shows a compilation of galvanostatic cycling tests of Cu∥Zn cells with varying amounts of the additive under different rates and capacities. The cycling tests used an electrochemically deposited zinc metal anode. 1-methyl-1-(2,2,3,3,3-pentafluoropropyl)pyrrolidinium bis(trifluoromethylsulfonyl)imide (PfmPyr)(TFSI) (also labelled as “Additive B”) was prepared and tested according to embodiments of our invention at three concentrations, 1 wt %; 2 wt % and 4 wt %.

The results demonstrate that trace amounts of the additive (e.g., ≤2 wt %) substantially improve the performance of zinc metal with plating and stripping from less than 85% to above 98% Coulombic efficiency. Notably, the pyrrolidinium additive shows the best performance as a low weight-percent additive with the particular imide anion. Experiments indicate that no more than about 4 wt % of the additive is soluble in our baseline electrolyte and the ideal amount is around 1 wt %.

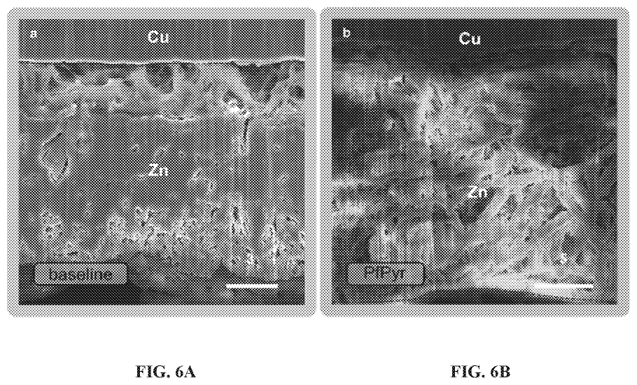

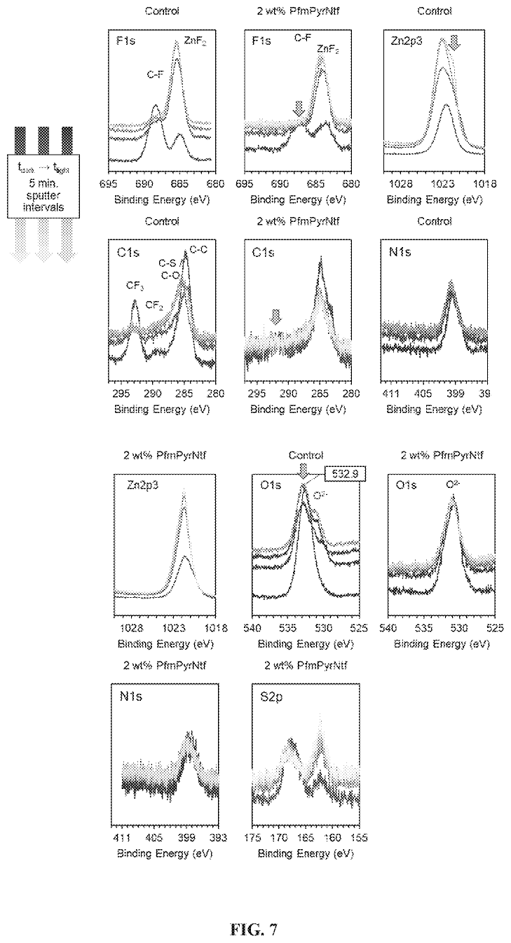

FIGS. 6A and 6B are photographs showing the morphological changes to zinc deposits due to the additive relative to the baseline electrolyte from focused-ion beam cross sections viewed by scanning electron microscopy. These photos show a stark difference in the morphology of the interphase and deposit due to the additive versus the control solution without the additive. The additive forms a tortuous structure with better reversibility but some risk of dendrite propagation during extended cycling,

FIG. 7 shows X-ray photoelectron spectra (XPS) of the surface of zinc deposited with and without the PfmPyr(TFSI) additive; the multiple scans refer to different depths within the deposit. Notably, the spectra with the additive show much weaker C-F signals, which correspond to reduced anion decomposition. From this chemical analysis, it can be concluded that the additive substantially reduces side reactions such as HER and anion decomposition before and during zinc deposition.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, and to describe the actual partial implementation in the laboratory of the system which was assembled using a combination of existing equipment and equipment that could be readily obtained by the inventors, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A zinc battery cell comprising
an anode formed of zinc metal or zinc alloy;
a cathode; and
an electrolyte composition comprising an additive molecule formed of a pyrrolidinium cation having at least one functional group and an anion.

2. The zinc battery cell of claim 1, wherein the cathode is selected from the group consisting of:
a vanadium oxide inorganic compound (HNaV₆O₁₆), a gaseous mixture with oxygen, and an electrochemically-active organic compound.

3. The zinc battery cell of claim 1, wherein the electrolyte composition further comprises one or more solvents, one or more salts, one or more additional additives, or any combination thereof.

4. The zinc battery cell of claim 1, wherein the additive molecule comprises no more than 5 wt. % of the electrolyte composition.

5. The zinc battery cell of claim 1, wherein the additive molecule comprises no more than 2 wt. % of the electrolyte composition.

6. The zinc battery cell of claim 1, wherein the Coulombic efficiency of the electrolyte composition in the battery cell is at least 90%.

7. The zinc battery cell of claim 1, wherein the concentration of the one or more salts is between 0.1 molal and 30 molal in the electrolyte composition.

8. The zinc battery cell of claim 1, wherein water comprises a solvent in the electrolyte composition.

9. The zinc battery of claim 1, wherein the pyrrolidinium cation comprises 1-methyl-1-(2,2,3,3,3-pentafluoropropyl)pyrrolidinium, 1-methyl-1-(2,2,2-trifluoroethyl)pyrrolidinium, or 1-methyl-1-(2,2,3,3,4,4,4-heptafluorobutyl)pyrrolidinium.

10. The zinc battery cell of claim 1, wherein the at least one functional group is selected from the group consisting of alkyl, alkene, alkenyl, alkynyl, F, CN, carbonate, ester, cyano-substituted alkyl groups, perfluoro, partially-fluorinated groups, ether(s), alcohol, SOₓ, O₂SOR (where R is a Si containing species), O₂SR (where R is fluorine, perfluoro, or other partially fluorinated bonded to the sulfur atom) and any combination thereof.

11. The zinc battery cell of claim 10, wherein at least one functional group is —CH₂—CF₂—CF₃.

12. The zinc battery of claim 1, wherein the anion is selected from the group consisting of: bis(trifluoromethane sulfonyl)imide (TFSI), bis(fluorosulfonyl)imide (FSI), trifluoromethanesulfonate (OTf), hexafluorophosphate (PF₆), perchlorate (ClO₄), tetrafluoroborate (BF₄), bis(oxalato)borate (BOB), difluoro(oxalate)borate (DFOB), sulfate (SO₄), nitrate (NO₃), chloride, bromide, fluoride, iodide, acetate, and any combination thereof.

13. The zinc battery of claim 1, where the additive molecule is 1-methyl-1-(2,2,3,3,3-pentafluoropropyl)pyrrolidinium bis(trifluoromethylsulfonyl)imide.

14. The zinc battery of claim 1, wherein a second electrolyte additive molecule or salt is included to further suppress dendrite growth.

15. The zinc battery of claim 1, configured as a rechargeable battery or a primary battery.

16. A method of forming a zinc battery cell comprising:
providing or forming an anode comprising zinc metal or zinc alloy;
providing or forming a cathode; and
providing or forming an electrolyte composition comprising an additive molecule formed of a pyrrolidinium cation having at least one functional group and an imide anion.
